(19) United States
(12) Patent Application Publication
(10) Pub. No.: US 2024/0069993 A1
(43) Pub. Date: Feb. 29, 2024

(54) AUTOMATIC FIELD MAPPING FOR A MOCKING SERVICE

(71) Applicant: Salesforce, inc., San Francisco, CA (US)

(72) Inventors: Gaurav Sagar, Bellevue, WA (US); Antonio Garrote, San Francisco, CA (US); Patricio Barletta, Brentwood, CA (US); Javier Isoldi, Buenos Aires (AR)

(21) Appl. No.: 17/822,114

(22) Filed: Aug. 24, 2022

(51) Int. Cl. G06F 9/54

(52) U.S. Cl. CPC G06F 9/547; G06F 9/541

(57) ABSTRACT

Methods, systems, apparatuses, devices, and computer program products are described. A mapping service may receive a user input indicating conditions for generating mock data values into application programming interface (API) fields. The mapping service may map a set of API fields to a set of mock collection library (MCL) fields using a mapping scheme. For example, the mapping service may map field names or descriptions of the API and MCL fields based on similarity scores determined using word embeddings. The mapping service may display a set of mapped fields and example mock data to a user. If the user rejects the mapped fields, the mapping service may remap the fields. Once the user accepts the mapped fields, the mapping service may generate a full set of mock data for the API (e.g., mock API responses to an API request) and store the mapping scheme.

### FIELD OF TECHNOLOGY

The present disclosure relates generally to data processing, and more specifically to automatic field mapping for a mocking service.

### BACKGROUND

A cloud platform (i.e., a computing platform for cloud computing) may be employed by many users to store, manage, and process data using a shared network of remote servers. Users may develop applications on the cloud platform to handle the storage, management, and processing of data. In some cases, the cloud platform may utilize a multi-tenant data processing system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

The cloud platform may interface with one or more databases, application programming interfaces (APIs), or web services. For example, the cloud platform may interface with a mocking service used to test functionalities and API calls associated with an API.

### BRIEF DESCRIPTION OF THE DRAWINGS

FIG. 1 illustrates an example of a data processing system that supports automatic field mapping for a mocking service in accordance with aspects of the present disclosure.

FIGS. 2 and 3 illustrate examples of computer architectures that support automatic field mapping for a mocking service in accordance with aspects of the present disclosure.

FIG. 4 illustrates an example of a process flow that supports automatic field mapping for a mocking service in accordance with aspects of the present disclosure.

FIG. 5 shows a block diagram of an apparatus that supports automatic field mapping for a mocking service in accordance with aspects of the present disclosure.

FIG. 6 shows a block diagram of a mapping service that supports automatic field mapping for a mocking service in accordance with aspects of the present disclosure.

FIG. 7 shows a diagram of a system including a device that supports automatic field mapping for a mocking service in accordance with aspects of the present disclosure.

FIGS. 8 through 11 show flowcharts illustrating methods that support automatic field mapping for a mocking service in accordance with aspects of the present disclosure.

### DETAILED DESCRIPTION

Some software applications may retrieve data from multiple data sources. For example, an application that provides the status of an online purchase may retrieve data from a first data source that includes shipping information related to the online purchase, a second data source that includes order status information related to the online purchase, and a third data source that includes details related to the item being purchased. The application may interface with these data sources via one or more application programming interfaces (APIs). In some examples, one or more of the data sources may be examples of source APIs, databases, or other types of data sources. Conventional techniques for retrieving data from source APIs (or other data sources) involve querying individual sources and merging or linking fields via hard-coded relationships.

A mocking service may be used to simulate the behavior of an API specification for development and testing purposes. In addition, the mocking service may be used to demo the API functionality to customers, partners and stakeholders. In some cases, a user of the mocking service may provide static examples of input data (e.g., requests) and responses for the mocking service to use. However, as such user-provided example data may not be real data, the example data may be limited in utility and quantity. That is, the mocking service may be unable to use the example data for some mock implementations. Additionally, a user of the mocking service may manually provide the example data, and as such, the example data may be limited in quantity (e.g., a customer may provide static examples as responses to API requests, which may be limited to four or five examples). In addition, the example data may fail to capture relationships between data fields, and the mocking service may fail to provide a means to simulate latencies of the actual data, which may limit the efficacy of the mocking service in mocking actual APIs for integration and development purposes.

In some cases, databases and mock collection libraries (MCL) that store a set of data and output randomly selected values from the stored data for a field or have methods to generate example data (e.g., a faker.js, which is a Javascript library used to generate fake examples of fields such as phone numbers, addresses, etc.) may be mapped to the various fields of the API specification and used to generate examples for each of the fields of the API which is to be mocked. However, this mapping of fields in a mock library to the fields in the API specification being mocked is a manual step and may be cumbersome for a user to do for API specifications with a large quantity of fields. Additionally, the examples generated in this way may still fail to resemble real API data as the examples may lack the relationships that may exist between fields of the API, and may also lack the structure of a field value such as the data from the real API (e.g. the length of a field UserId may be equal to 8 characters). As such, a mocking service may be ineffective at a large scale, which may result in workflow inefficiencies.

One or more aspects of the present disclosure provide techniques for performing automatic field mapping for a mocking service to generate example data. A mapping service may map a set of API fields to a set of MCL fields using a mapping scheme, where the mapping scheme may include a logic for mapping respective API fields to respective API fields. In some cases, a user (e.g., an API architect or an administrative user) may indicate a set of conditions or rules for generating values of mock data (e.g., example data, sample data), into a set of API fields of an API. Based on the set of conditions, a mapping service may either filter out examples from the MCL which may fail to meet the conditions, or generate values for the fields with or without using the MCL example data. For example, if a user provides a condition such as “NewBalance=OldBalance+transferAmount,” the MCL may generate the OldBalance and the transferAmount, and the mapping service may use the generated OldBalance and transferAmount as inputs to generate the NewBalance. That is, the NewBalance is generated by the mapping service instead of the MCL, however the inputs are from the MCL. Alternatively, if the user provides a regular expression pattern to generate a social security number (SSN) such as “∧\d{3}-?\d{2}-?\d{4}$,” then the mapping service may refrain from obtaining example data from the MCL, and instead may directly generate random example data using the regular expression pattern.

In some examples, the MCL may be a fake data generation library (e.g., faker.js) that is separate from the API specification that is to be mocked. The mapping service may indicate a set of mapped fields to the user (e.g., via a user interface), and in some examples, the user may reject the mapped fields. For example, the user may reject the mapped fields if one or more of the mapped fields fails to satisfy the criteria established by the user. Accordingly, the mapping service may reconfigure the mapping scheme to follow a different logic, use a different set of criteria, or both, and may indicate additional sets of the mapped fields to the user until the user accepts the mapping. Based on receiving an indication that the user accepts the mapped fields and the mapping scheme, the mapping service may generate a set of mock data for the API fields using the mapping scheme, and store the mapping scheme for later use by the user (e.g., to obtain sample API responses to an API request).

Aspects of the disclosure are initially described in the context of an environment supporting an on-demand database service. Aspects of the disclosure are then described in the context of computing architectures and process flows. Aspects of the disclosure are further illustrated by and described with reference to apparatus diagrams, system diagrams, and flowcharts that relate to automatic field mapping for a mocking service.

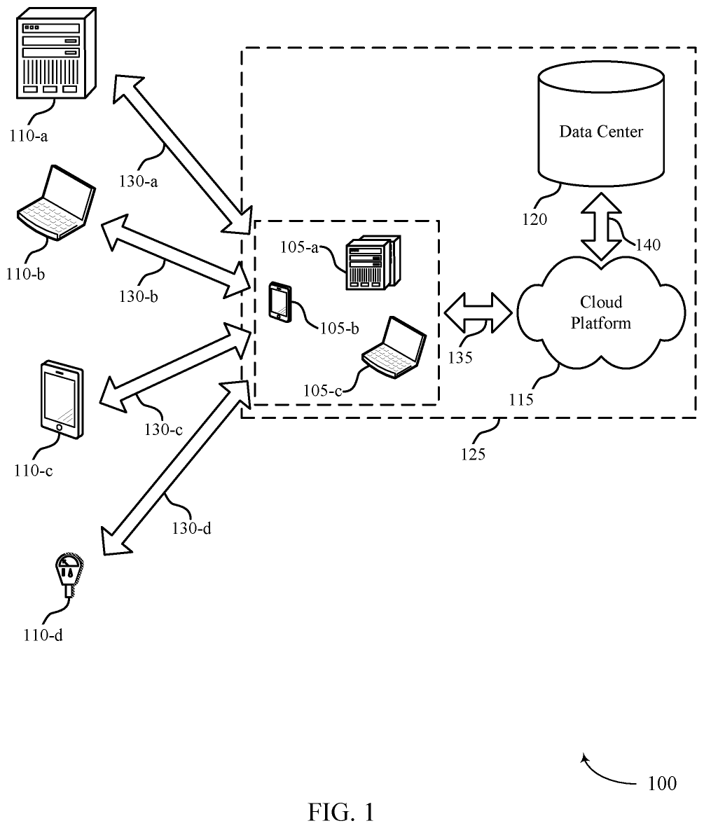

FIG. 1 illustrates an example of a system 100 for cloud computing that supports automatic field mapping for a mocking service in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level, and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

One or both of the cloud platform 115 or the subsystem 125 may support a server, such as a mocking server, which may host an API mocking service. In some cases, the server may include aspects of an application server as described herein. The mocking service may support secure, efficient API testing and validating. The mocking service may expose an endpoint of the API to a user, which may be an example of a cloud client 105 or a contact 110. The user may be an example of a tenant of the mocking server. The user may use the endpoint to test the API prior to full implementation (e.g., publishing) of the API. The testing may be based on an API specification and its underlying metadata. An API specification may refer to a document or program that defines at least a portion of the functionality of an API (e.g., including any combination of behaviors, definitions, documentation, etc., for the API). The users of the mocking service may use the mocking service to demo what the actual API may be like to stakeholders, and to develop, test, and debug integrations until the actual API may be used.

In some other systems, a mocking service may use static examples of input data (e.g., API requests) and responses (e.g., API responses) provided by a user of the mocking service. However, such example data may be limited in utility as it is not real data. In addition, the example data may be limited in quantity as they are provided manually provided by the user, and the example data may fail to capture relationships between data fields, which may restrict what mock implementations the mock service is able to create. Some systems may support databases that store example data or MCLs (e.g., faker.js) generate example data. While such example data may provide more utility for mock implementations than user-provided example data, the mapping of fields in a mock library or the database to the fields in the API specification being mocked is a manual step and may be cumbersome for a user to do for API specifications with a large quantity of fields. Additionally, the examples generated in this way may still fail to resemble real API data as they may lack the relationships that may exist between fields of the API.

To enhance functionality of the mocking service in the system 100, automatic field mapping may be configured such that a mocking service may use a set of mock data for API mocking purposes. In some examples, a user (e.g., an API architect or an administrative user) may indicate a set of conditions or rules for generating values of mock data (e.g., example data, sample data) into a set of API fields. Based on the set of conditions, a mapping service or a mocking server (e.g., corresponding to the cloud platform 115) may map the set of API fields to a set of mock collection library (MCL) fields using a mapping scheme, where the mapping scheme may include a logic for mapping respective API fields to respective MCL fields. The mapping service may indicate a set of mapped fields to the user (e.g., via a user interface of a contact 110), and in some examples, the user may reject the mapped fields. For example, the user may reject the mapped fields if the automatic mapping mapped a field ‘MusicBand’ (e.g., Queen, The Beatles, etc.) from the MCL to an API field ‘SalaryBand,’ as the user may be expecting example data of salart ranges (e.g., ‘$50 k-$70 k,’ $60 k-$90 k,′ etc.). Accordingly, the mapping service may reconfigure the mapping scheme to follow a different logic, use a different set of criteria, or both, and may indicate additional sets of the mapped fields to the user until the user accepts the mapping. Based on receiving an indication that the user accepts the mapped fields and the mapping scheme, the mapping service may generate a set of mock data for the API fields using the mapping scheme (e.g., on the fly), and store the mapping scheme for later use by the user, for example in the data center 120.

Generating the set of mock data based on a mapping between API fields and MCL fields may provide enhanced functionality of the system 100 when running mock implementations of APIs. For example, the mapping service may iterate the mapping scheme to improve the mapping between the API fields and the MCL fields until a user indicates approval of the mapping. The mapping service may update criteria and logic used for the mapping and generate a set of mock data based on the improved mapping. Thus, by using the set of mock data for a mock implementation, the mocking service may provide a platform for realistic API integration and testing. In addition, storing the set of mock data and the mapping scheme for later use (e.g., to produce a set of mock responses to an API request) may enable a user to retrieve mock data at any given time, which may result in improved workflow efficiencies.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

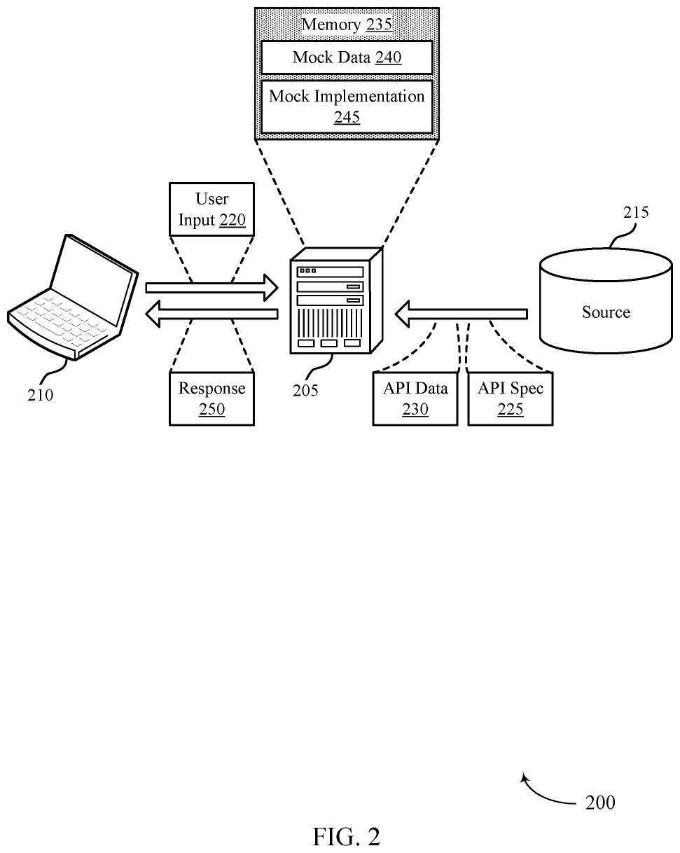

FIG. 2 illustrates an example of a computing architecture 200 that supports automatic field mapping for a mocking service in accordance with aspects of the present disclosure. The computing architecture 200 may implement or be implemented by aspects of the data processing system 100. For example, the computing architecture 200 may include a server 205, which may be implemented by aspects of a cloud platform 115 or a subsystem 125 described with reference to FIG. 1. The server 205 may be an example of a mocking server or an application server, and may be a single server, a server cluster, a container, a virtual machine, or any other device or system for running mock implementations 245 of API specifications 225 or API data 230. An API specification may include a document or program that defines at least a portion of the functionality of an API (e.g., including any combination of behaviors, definitions, documentation, etc., for the API), and the API data 230 may include a set of API requests and a corresponding set of API responses.

The server 205 may receive information from a user device 210 (e.g., via a user interface or a machine-to-machine data transfer) to generate mock data 240 (e.g., sample data, example data), and execute mock implementations 245. Additionally, in some cases, the server 205 may retrieve the API specifications 225 or the API data 230 from a source 215. A source 215 may be an example of an internal repository to the server 205 or a system served by the server 205, an external repository to the server 205, a shared code repository, a file upload, a database, a data store, a cloud-based storage entity, or some combination of these or other storage systems. In some cases, the server 205 or user device 210 may operate as the source 215 for an API specification 225 or the API data 230.

The computing architecture 200 may support secure, efficient API testing and validation. For example, a user operating the user device 210 may use the mocking service to simulate responses to an API in order to test that the API is functioning properly, troubleshoot problems, demo the API, implement and test downstream APIs, or any combination thereof.

In some examples, the server 205 may support a mapping service, a mocking service, or some other service that may be used to generate the mock data 240 and execute the mock implementations 245. The server 205 may store the mock data 240, the mock implementations 245, or both in a memory 235. Alternatively, the mock data 240, the mock implementations 245, or both may be stored in some external data store. In some cases, the server 205 may generate a mock implementation 245 for an API based on the API specification 225 or the API data 230, which may detail features, processes, and functions of the API being mocked. In addition, the server 205 may use the API specification 225 or the API data 230 to inform the mock data 240, which may include mock API responses to a set of API requests. In some cases, the server 205 may include a mapping service that may generate a mapping between a set of API fields of the API specification 225 to a set of fields of an MCL, where the mapping may enable the server 205 to generate values of the mock data 240 into the API fields of the API specification 225. In this way, the server 205 may use the mock data 240 for a mock implementation 245, which may increase workflow efficiencies and increase the efficacy and accuracy of the mock implementation 245.

Running the mock implementation 245 based on the mock data 240 may result in a response 250. The response 250 (e.g., a mock API response, a sample API response), may simulate one or more API responses to one or more API requests. As such, the response 250 may be based on information in the API specification 225 (e.g., parameters, fields, methods, data types, metadata, etc.) or the API data 230 (e.g., API requests and corresponding API parameters). That is, in some examples, the response 250 may correspond to a set of values of mock data generated into a set of API fields of an API. Alternatively, the response 250 may include mock API responses corresponding to one or more API requests of the API data 230, such that the response 250 mimics one or more API responses of the API data 230. In some examples, the server 205 may retrieve data included in the response 250 from the memory 235 or some other data store for transmission to the user device 210 based on receiving a request from the user (e.g., via the user input 220). The user device 210 may display the response 250 via a user interface. Based on the response 250 displayed via the user interface, the user may determine how to modify an API, an API specification 225, the API data 230 (e.g., an API request), or any combination thereof.

In some examples, a user (e.g., an API architect or an administrative user) may indicate, via the user input 220, a set of conditions or rules for generating values of the mock data 240 into a set of API fields of an API. Based on the set of conditions, a mapping service may either filter out examples from MCL which fail to meet the conditions, or generate values for the fields with or without using the MCL examples. That is, API fields may be generated from the MCL, where then the user conditions may be used to filter out generated example API fields that fail to meet the user conditions, or where the server 205 may generate the example API fields with or without using the MCL.

The server 205 may indicate a set of mapped fields to the user (e.g., via a user interface of the user device 210), and in some examples, the user may reject the mapped fields. For example, the user may reject the mapped fields if the examples generated from one or more of the mapped fields fail to resemble the example data the user may have predicted. For example, if a field in the MCL ‘MusicBand’ (e.g. Queen, The Beatles, etc.) is mapped to an API field ‘SalaryBand’ for which the user may be expecting example data of salary ranges (e.g. ‘$50 k-$70 k’, ‘$60 k-90 k’, etc.), the user may reject the mapping of this field. Accordingly, the server 205 may reconfigure the mapping scheme to follow a different logic, use a different set of criteria, or both, and may indicate additional sets of the mapped fields to the user until the user accepts the mapping. Based on receiving an indication that the user accepts the mapped fields and the mapping scheme (e.g., via a user input 220), the server 205 may generate the mock data 240 for the API fields of the API specification 225 and store the mapping scheme (e.g., which may correspond to a mock implementation 245) for later use by the user. Other techniques for generating mock data 240 at the server 205 are contemplated within the scope of the present disclosure.

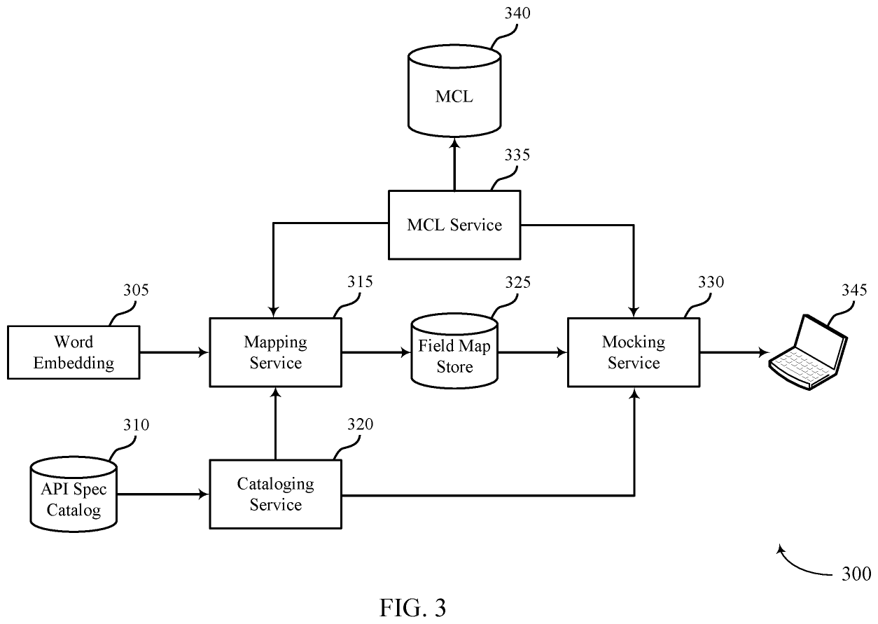

FIG. 3 illustrates an example of a computing architecture 300 that supports automatic field mapping for a mocking service in accordance with aspects of the present disclosure. The computing architecture 300 may implement or be implemented by aspects of the data processing system 100 or the computing architecture 200. For example, the computing architecture 300 may include a mapping service 315, a cataloging service 320, a mocking service 330, and an MCL service 335, which may be implemented by aspects of a cloud platform 115 or a subsystem 125 described with reference to FIG. 1, or a server 205 described with reference to FIG. 2. In some examples, one or more of the mapping service 315, the cataloging service 320, the mocking service 330, and the MCL service 335 may be examples of an application server, and may be a single server, a server cluster, a container, a virtual machine, or any other device or system for running mock implementations of API specifications. In some examples, the systems or servers supporting the mapping service 315, the cataloging service 320, the mocking service 330, and the MCL service 335 may each include computing systems that are logically or physically separated.

The computing architecture 300 may support automatic field mapping for the mocking service 330, which may enable the mocking service 330 to generate mock data (e.g., sample data) for API development, integration, and testing. In some examples, a set of mock data may be generated based on identifying a mapping between API fields of an API and fields of an MCL, such as an MCL 340. A user (e.g., an account owner or an administrative user) may select a RESTful API Modeling Language (RAML) or an OpenAPI Specification (OAS) of an API, which may include definitions of types and fields of a corresponding API specification, from an API specification catalog 310 or an API designer application.

The user may update the API specification with a set of conditions (e.g., criteria) that particular fields of the API specification are required to meet to be valid. For example, the set of conditions may include a length of an API field (e.g., len(user_id)=8), a data type of an API field (e.g., number, string), instructions for generating an API field (e.g., updated_account_balance=old_account_balance+(1.01*amount) if mode==“atm” else old_account_balance+amount, which may indicate that a bank charges 1% for ATM transactions), or any other conditions associated with an API. In some examples, the mapping service 315 may receive, via a user interface, a first user input indicating the set of conditions, which the mapping service 315 may use to generate values of mock data into a set of API fields of the API specification.

The set of conditions may be stored as annotations or extensions in the API specification, and may be used to pass in a set of parameters when making calls to an MCL service. For example, the first user input may indicate a latency associated with returning back the response in the form of mock data to request made by a user of the mocking service 330 by using the condition specified in the API specification as annotation and extension (e.g., Meanlatency: 300 ms; SDlatency: 50 ms), which may make the mock data more realistic for API integration, testing, and demoing to stakeholders. In some examples, the annotations or extensions may add information to the API specification. For example, for a given example API, a user may indicate an optional seed to create same random examples of API field values (e.g., seed: 1234), a quantity of values in an array of objects (e.g., arraylen: 5), or any combination thereof, in addition to any other information that may substantiate the API specification.

In some cases, the API specification catalog 310 may pass the API specification and the set of conditions to a cataloging service 320, which may store a structure of the API specification and the set of conditions. The user may select a button to turn on the mocking service 330 (e.g., in an API designer application), and the API specification and corresponding fields may be passed from the cataloging service 320 to the mapping service 315. In some examples, the mapping service 315 may load a pre-trained word embeddings model (e.g., Word2Vec) that captures a semantic and syntactic meaning of a word. In some examples, the mapping service 315 may create a word embedding model using a free textual dataset. Some word embeddings models may be used in natural language processing (NLP) to represent words for text analysis, for example in the form of a real-valued vector that encodes meanings of each word or group of words such that the words that are relatively close in the vector space are expected to have similar meanings. Accordingly, using the word embeddings model 305, the mapping service 315 may identify closest resembling fields corresponding to the set of API fields.

Additionally, an MCL service 335 may retrieve a set of MCL fields from the MCL 340, which may be a data source that is separate from the API specification catalog 310. In some examples, a documentation structure of the MCL 340 may include a description of a field, examples, and methods associated with each MCL field. For example, an MCL field may be a “CurrencyCode” field that is described as codes of currencies of money set by countries which are used in exchange of currency between entities. Examples may include a Euro (EUR), a United States Dollar (USD), an Indian Rupee (INR), a Great British Pound (GBP), a Japanese Yen (JPY), and a Swiss Franc (CHF), among other examples. A method associated with the “CurrencyCode” field may indicate a generative function used to generate that field such as mcl.money.currencycode( ).

The MCL 340 may be a fake data generation library (e.g., faker.js), which may be an existing library or a custom-created faker library if it is to be domain-specific. In some examples, the MCL 340 may include pre-stored values of elements that may generate a value of an API. For example, the MCL 340 may include multiple elements (e.g., street, city, state, etc.) for a given API field, and each element may have pre-set values. The MCL 340 may provide a function (e.g., a generative function, field methods) for the user to obtain a randomly-selected combination across the multiple elements as a mock (e.g., fake, example) value for a field.

The MCL service 335 may pass the set of MCL fields to the mapping service 315 such that the mapping service 315 may create a mapping between the set of API fields and the set of MCL fields. In some cases, if a user provides a regular expression (regex) pattern via a user input to the mapping service 315, the mapping service 315 may create a function to generate random values of the API field based on the regular expression. For example, the mapping service 315 may create a set of mock data based on random digits, random characters, and random numbers as indicated in the regular expression.

Additionally, or alternatively, the mapping service 315 may map the set of API fields of the API specification catalog 310 to the set of MCL fields of the MCL 340 based on the one or conditions specified by the user and based on a mapping scheme, where the mapping scheme uses a logic for mapping respective API fields to respective MCL fields. For example, the mapping service 315 may map the set of API fields to the set of MCL fields based on generating a field-method mapping using a logic that may occur over up to three passes, where a first pass may be based on field names of an MCL field and an API field, a second pass may be based on descriptions of the MCL field and the API field, and the third pass may be based on examples of values of the MCL field and the API field.

In the first pass of the field mapping, for each API field included in the API specification, the mapping service 315 may identify an MCL field (e.g., by its name) from the MCL 340 that has a highest similarity score based on the word embeddings model 305, and map it to an API field of the API specification. That is, the mapping service 315 may determine a similarity score associated with a first MCL field of the set of MCL fields and a first API field of the set of API fields based on comparing the set of API fields and the set of MCL fields, and the mapping service 315 may map the first API field and the first MCL field based on the similarity score being a highest similarity score associated with the field-level comparison of the set of MCL fields and the set of API fields (e.g., a highest similarity score for the first pass). In some examples, the mapping service 315 may use the word embeddings model 305 to determine the similarity scores (e.g., cosine similarity scores). For example, the mapping service 315 may use the word embeddings model 305 to determine which words or sentences of an API field map to which words or sentences of an MCL field, and subsequently to determine how similar the respective words or sentences are in meaning (e.g., using a cosine similarity measure), which may dictate the similarity scores. The mapping service 315 may map the first API field and the first MCL field with the highest similarity score. For example, the mapping service 315 may map the “CurrencyCode” MCL field to a “currency” field of the API specification based on the use of the word “currency” in both the MCL field and the API field.

After using the similarity scores to map respective API fields to respective MCL fields, the mapping service 315 may show a user a set of mapped fields and corresponding mock data generated (e.g., API field samples, values of a given API field) based on the mapped fields (e.g., 5 examples). For example, the mapping service 315 may cause, for display at a user interface of the mapping service 315, an indication of the set of mapped fields based on performing the mapping. In some examples, the user may reject one or more of the mapped fields or one or more API field samples generated based on the mapped fields. For example, the user may reject a mapping between an MCL field and an API field if the sample generated from the MCL, which may be a generated mock API response, fails to resemble what the user may expect as values for that API field in the real API. For example, the user may reject the mapped fields if the automatic mapping mapped an MCL field ‘MusicBand’ (e.g., Queen, The Beatles, etc.) from the MCL to an API field ‘SalaryBand’ as the user may expect example data of salary ranges (e.g., ‘$50 k-$70 k,’ ‘$60 k-$90 k,’ etc.). In some examples, the mapping service 315 may receive, via a user interface, a second user input indicating the rejection of the one or more mapped fields or the one or more API field samples.

Based on the user rejecting the one or more mapped fields, the mapping service 315 may perform the second pass at the mapping based on descriptions of the mapped fields. In such cases, for all API field samples rejected by the user, the mapping service 315 may identify an MCL field from the MCL 340 that has a highest similarity score based on a description of the API field in the API specification catalog 310 and a description of the MCL field in the MCL 340. That is, the mapping service 315 may identify one or more MCL fields that are associated with a highest similarity for the second pass based on a set of descriptions (e.g., based on a description-level comparison) for the one or more MCL fields and one or more API fields, where the one or more MCL fields may be associated with the one or more mapped fields rejected by the user.

The mapping service 315 may remap the API fields associated with the one or more rejected mapped fields to the MCL fields and display, at a user interface, an indication of the remapped fields. That is, the mapping service 315 may generate one or more API field samples (e.g., 5 examples) based on the remapped API and MCL fields that were originally rejected by the user and display the API field samples to the user along with the mapped fields. For example, the mapping service 315 may map the description of the MCL “CurrencyCode” field which may be described as codes of currencies of money set by countries which are used in exchange of currency between entities, to a description of an API “currency” field that is described as a currency code of the system of money in general use in a particular country. In this way, the mapping service 315 may use more contextual mapping (e.g., NLP) than in the first pass, which may be based on keyword mapping.

In some cases, the user may again reject one or more of the remapped fields if one or more corresponding API field samples fail to resemble what the user may expect as values for that API field in the real API. In such cases, the mapping service 315 may perform the third pass of the mapping between the API fields and the MCL fields to further improve the mapping, which may be based on example values of the API fields and the MCL fields. For all API field samples rejected by the user, the mapping service 315 may request that the user provide examples of the values for corresponding API fields. That is, the mapping service may transmit a request for a set of example values (e.g., mock data) corresponding to the one or more mapped fields rejected by the user.

The mapping service 315 may identify the MCL field that has a highest similarity score based on the example values provided by the user and corresponding example values of MCL fields stored in the MCL 340 (e.g., based on an example-level comparison). The mapping service 315 may then remap API fields associated with the one or more rejected mapped fields to the MCL fields and display, at a user interface, an indication of the remapped fields. That is, the mapping service 315 may generate one or more API field samples (e.g., 5 examples) based on the remapped API and MCL fields that were originally rejected by the user and the example values provided by the user, and the mapping service 315 may display the API field samples to the user along with the remapped fields. For example, the mapping service 315 may map the MCL “CurrencyCode” field to the API “currency” field based on an example of the MCL field being EUR, and the value of the API field being EUR.

If the user again rejects one or more of the remapped fields (e.g., based on the corresponding API field samples again failing to resemble what the user may expect as values for that API field in the real API), the mapping service 315 may save the example values provided by user for the API fields as static value for those API fields. In this way, the example (e.g., mock, sample) values of the API fields may not be based on a mapping to MCL fields, but on values provided by the user. In some examples, after any pass of the mapping between the API fields and the MCL fields, the user may accept the mapped fields based on the API field samples generated from the mapping. For example, instead of receiving an indication that the user rejected one or more mapped fields, the mapping service 315 may receive, via a user indication, a second user input indicating an acceptance of one or more of the mapped fields based on the corresponding generated API field samples satisfying the set of conditions specified by the user. Based on receiving the indication of the acceptance, the mapping service 315 may generate a set of mock data (e.g., a full set of API field samples) using the mapping between the API fields and the MCL fields, where the mock data may satisfy the set of conditions.

In addition, the mapping service 315 may store the mapping scheme. For example, the mapping service 315 may store the mapping scheme (e.g., a field map) and the set of conditions in a field map store 325. In some examples, a mocking service 330 may generate a set of mock data from the field map store 325 on the fly based on receiving an API request, where the set of mock data may include a set of generated mock responses to the API request. For example, the mocking service 330 may call a generation service of the mapping service 315 (where the generation service may generate the mock data) to generate a mock API response to a particular API request.

In some examples, the mapping scheme for a given API may indicate a set of API fields and corresponding generative functions based on the MCL 340, where the generative functions may be used to generate API field samples for a given API field based on the MCL 340. In addition, the generative functions may indicate any relevant conditions associated with generating an API field sample as specified by the user. For example, an API field “Address.city” may correspond to a generative function “mcl.address.city( )” which may indicate a mapping between the “Address.city” field of an API specification to an “address.city” field of the MCL 340 with no conditions. Alternatively, an API field “Transaction.amount” may correspond to a generative function “mcl.finance.amount (0.10, 99999.0),” which may indicate a mapping between the “Transaction.amount” field of the API specification to a “finance.amount” field of the MCL 340, with a condition that the transaction amount may be between 0.10 dollars and 99,999 dollars of a specified currency. in this way, the mapping service 315 may generate a mock transaction amount (e.g., a random value for the “Transaction.amount” API field) that is between 0.10 dollars and 99,999 dollars of the specified currency.

The mocking service 330 may retrieve the mapping scheme (e.g., field map) and the set of conditions from the field map store 325, and the mocking service 330 may obtain a set of MCL fields from the MCL service 335 based on the augmented field methods (e.g., generative functions) detailed in the mapping scheme. The mapping scheme may indicate API version details, a set of API fields from an API specification, and the generative functions (e.g., methods for how to generate the mock data based on a set of MCL fields from the MCL 340). Such generative functions may be augmented with the set of conditions provided by the user. As such, the mocking service 330 may perform declarative data validation based on the conditions of the API specification. The mocking service 330 may then use the augmented field methods in the mapping scheme to generate the set of mock data (e.g., mock API responses), which the mocking service 330 may organize as per the structure of the API specification stored in the cataloging service 320. Accordingly, the mocking service 330 may indicate and send many unique responses for different API requests to the user on the fly.

In some examples, the mocking service 330 may return the set of mock data to the user via a user device 345 (e.g., a contact 110, a client), where the set of mock data may be returned as an API call response. For example, the mocking service 330 may display the set of mock data via a user interface of the user device 345. In some examples, the mocking service 330 may wait a random time period (e.g., milliseconds) before returning the response to the use, where the random time period may be based on set of time periods having a normal distribution having a mean and standard deviation specified in parameters associated with the set of mock data to simulate latency of the real API. In addition, the mocking service 330 may provide latencies associated with the mock data from the normal distribution indicated by the user via the first user input. In some cases, mock parameters associated with the mock data may have a field seed, which may ensure that the same random values of the mock data are generated each time the mocking service 330 is reinitiated. For example, for a seed “1234,” a field value for FirstName may always be “Alex, Ben, Sharpe, Austin.” The order may be preserved such that a first API call may return Alex, a second API call may return Ben, and so on (e.g., that is, without the seed, the first value may be Ben, Sharpe, or Austin instead of Alex). In some examples, the user may have complete control to override the mock data, for example, by indicating specific fields to use or specific field values.

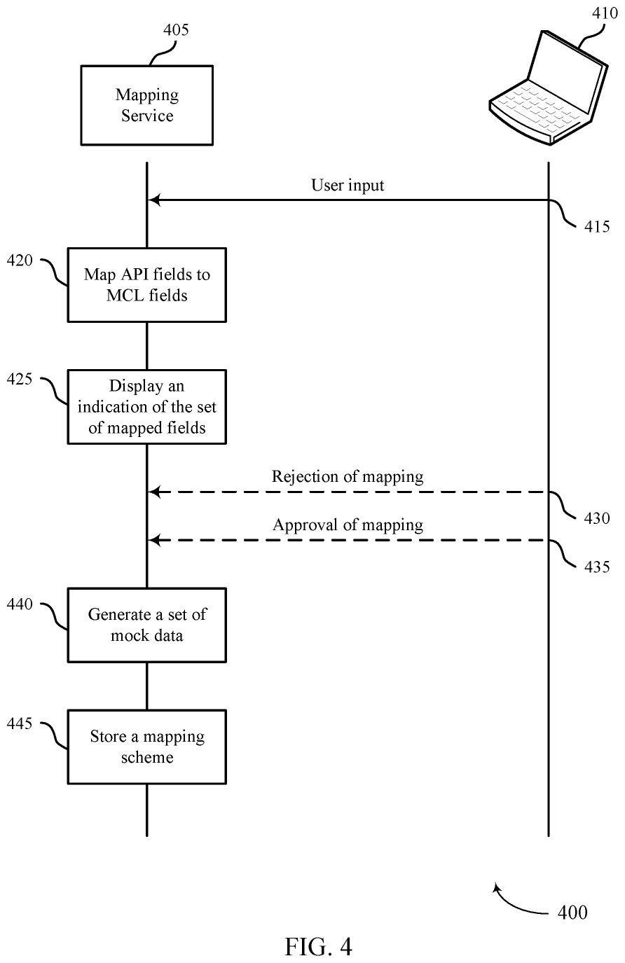

FIG. 4 illustrates an example of a process flow 400 that supports automatic field mapping for a mocking service in accordance with aspects of the present disclosure. The process flow 400 may implement or be implemented by aspects of the data processing system 100 or the computing architecture 200. For example, the process flow 400 may include a mapping service 405 and a user device 410, which may be examples of corresponding services and platforms described with reference to FIGS. 1 and 2. In the following description of the process flow 400, operations between the mapping service 405 and the user device 410 may be performed in a different order or at a different time than as shown. Additionally, or alternatively, some operations may be omitted from the process flow 400, and other operations may be added to the process flow 400. The process flow 400 may support techniques for automatic field mapping by the mapping service 405 for a mocking service.

At 415, the mapping service 405 may receive, via a user interface and from the user device 410 operated by a user, a first user input indicating one or more conditions for generating values of mock data into a set of API fields of an API. The one or more conditions may indicate a length of an API field (e.g., 8 characters), a type of an API field (e.g., numerical, string), and the like. In addition, the first user input may indicate a latency associated with the API.

At 420, the mapping service 405 may map the set of API fields of the API to a set of MCL fields of a data source that is separate from the API based on the one or more conditions and a mapping scheme, where the mapping scheme may include a logic for mapping respective API fields to respective MCL fields. In some examples, the mapping may be based on a similarity score between field names, descriptions, or examples associated with the API fields and the MCL fields, where the mapping service 405 may determine a similarity score using a word embeddings model.

At 425, the mapping service 405 may cause, for display at the user interface, an indication of a set of mapped fields based on the mapping. For example, using the mapping scheme and the MCL fields, the mapping service 405 may generate the set of mapped fields and corresponding mock data examples (e.g., API field samples) for the mapped API fields that are generated based on the mapping scheme. The mapping service 405 may display the mapped fields and the mock data examples to the user.

At 430, the mapping service 405 may receive, via the user interface and from the user device 410, a second user input indicating a rejection of the one or more mapped fields of the set of mapped fields. For example, a user may reject the one or more mapped fields if the mock data examples fails to resemble the example data the user may have expected for a real API. Based on the rejection, the mapping service 405 may remap the set of API fields and the set of MCL fields using different criteria for the mapping scheme. For example, the mapping service 405 may map the fields based on matching descriptions of the fields rather than matching field names.

At 435, the mapping service 405 may receive, via the user interface and from the user device 410, the second user input indicating an acceptance of the one or more mapped fields of the set of mapped fields. For example, instead of a user rejecting the one or more mapped fields initially, or after the mapping service 405 has remapped the fields using different criteria, the user may accept the mapped fields based on the mock data examples satisfying the one or more conditions specified by the user.

At 440, the mapping service 405 may generate a set of mock data for the set of API fields based on the mapping and a response to the indication. That is, based on receiving the second user input indicating the user's approval of the mapped fields, the mapping service 405 may generate a full set of mock data using the mapping scheme, where the set of mock data may include one or more mock API responses to an API request.

At 445, the mapping service 405 may store the mapping scheme based on generating the set of mock data. The mapping service 405 may store the mapping scheme in a field map store or some other data store. In some examples, a mocking service may retrieve the stored mapping scheme to generate mock data on the fly based on receiving an API request.

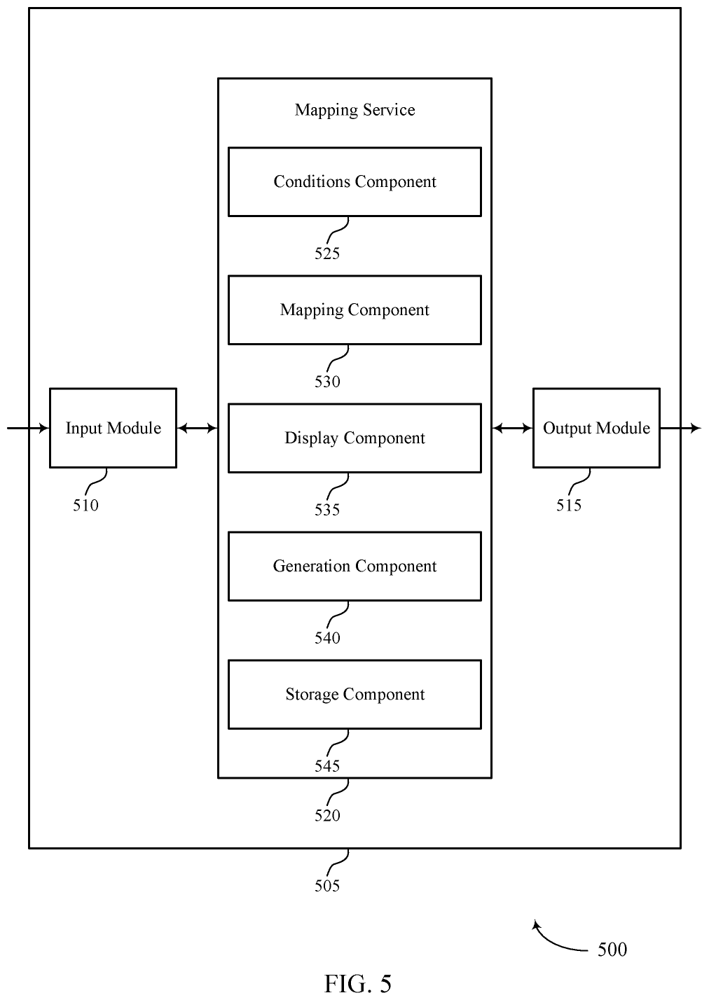

FIG. 5 shows a block diagram 500 of a device 505 that supports automatic field mapping for a mocking service in accordance with aspects of the present disclosure. The device 505 may include an input module 510, an output module 515, and a mapping service 520. The device 505 may also include a processor. Each of these components may be in communication with one another (e.g., via one or more buses).

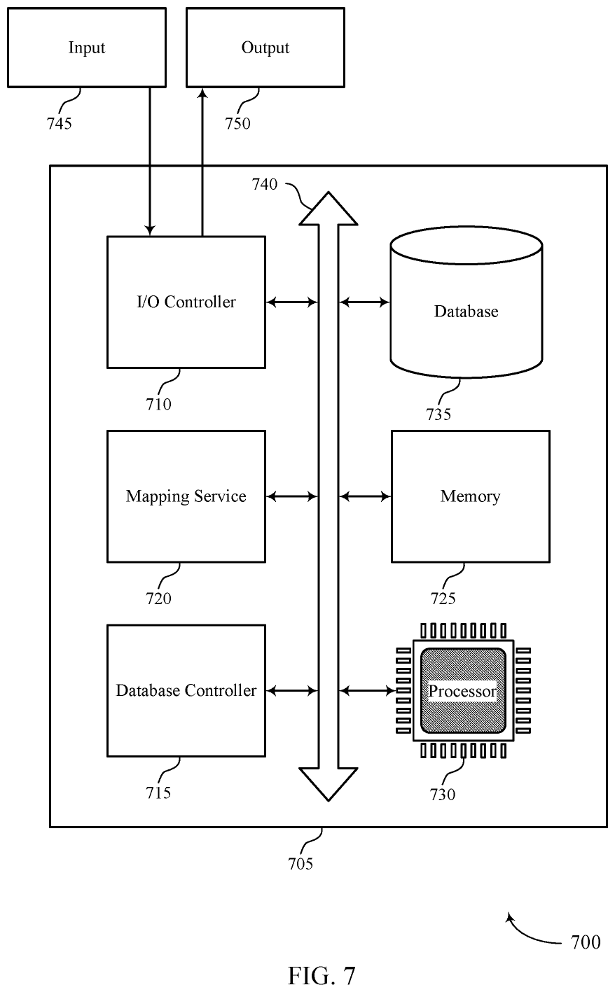

The input module 510 may manage input signals for the device 505. For example, the input module 510 may identify input signals based on an interaction with a modem, a keyboard, a mouse, a touchscreen, or a similar device. These input signals may be associated with user input or processing at other components or devices. In some cases, the input module 510 may utilize an operating system such as iOS®, ANDROID®, MS-DOS®, MS-WINDOWS®, OS/2®, UNIX®, LINUX®, or another known operating system to handle input signals. The input module 510 may send aspects of these input signals to other components of the device 505 for processing. For example, the input module 510 may transmit input signals to the mapping service 520 to support automatic field mapping for a mocking service. In some cases, the input module 510 may be a component of an I/O controller 710 as described with reference to FIG. 7.

The output module 515 may manage output signals for the device 505. For example, the output module 515 may receive signals from other components of the device 505, such as the mapping service 520, and may transmit these signals to other components or devices. In some examples, the output module 515 may transmit output signals for display in a user interface, for storage in a database or data store, for further processing at a server or server cluster, or for any other processes at any number of devices or systems. In some cases, the output module 515 may be a component of an I/O controller 710 as described with reference to FIG. 7.

For example, the mapping service 520 may include a conditions component 525, a mapping component 530, a display component 535, a generation component 540, a storage component 545, or any combination thereof. In some examples, the mapping service 520, or various components thereof, may be configured to perform various operations (e.g., receiving, monitoring, transmitting) using or otherwise in cooperation with the input module 510, the output module 515, or both. For example, the mapping service 520 may receive information from the input module 510, send information to the output module 515, or be integrated in combination with the input module 510, the output module 515, or both to receive information, transmit information, or perform various other operations as described herein.

The mapping service 520 may support data processing in accordance with examples as disclosed herein. The conditions component 525 may be configured as or otherwise support a means for receiving, via a user interface of a mapping service, a first user input indicating one or more conditions for generating values of mock data into a set of API fields of an API. The mapping component 530 may be configured as or otherwise support a means for mapping the set of API fields of the API to a set of MCL fields of a data source that is separate from the API based on the one or more conditions and a mapping scheme, where the mapping scheme includes a logic for mapping respective API fields to respective MCL fields. The display component 535 may be configured as or otherwise support a means for causing, for display at the user interface of the mapping service, an indication of a set of mapped fields based on the mapping. The generation component 540 may be configured as or otherwise support a means for generating a set of mock data for the set of API fields based on the mapping and a response to the indication. The storage component 545 may be configured as or otherwise support a means for storing the mapping scheme based on the generating.

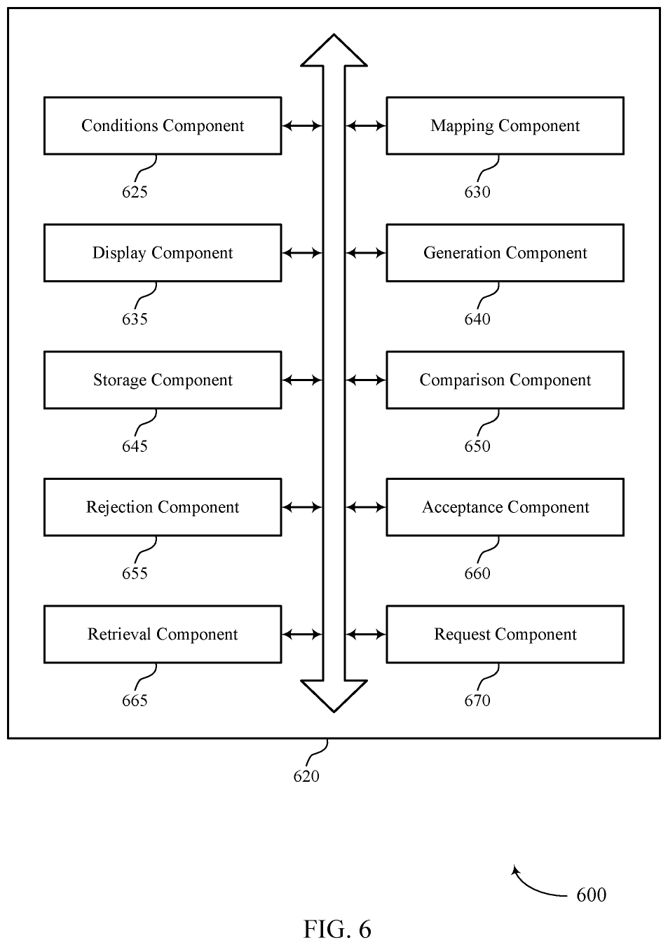

FIG. 6 shows a block diagram 600 of a mapping service 620 that supports automatic field mapping for a mocking service in accordance with aspects of the present disclosure. The mapping service 620 may be an example of aspects of a mapping service or a mapping service 520, or both, as described herein. The mapping service 620, or various components thereof, may be an example of means for performing various aspects of automatic field mapping for a mocking service as described herein. For example, the mapping service 620 may include a conditions component 625, a mapping component 630, a display component 635, a generation component 640, a storage component 645, a comparison component 650, a rejection component 655, an acceptance component 660, a retrieval component 665, a request component 670, or any combination thereof. Each of these components may communicate, directly or indirectly, with one another (e.g., via one or more buses).

The mapping service 620 may support data processing in accordance with examples as disclosed herein. The conditions component 625 may be configured as or otherwise support a means for receiving, via a user interface of a mapping service, a first user input indicating one or more conditions for generating values of mock data into a set of API fields of an API. The mapping component 630 may be configured as or otherwise support a means for mapping the set of API fields of the API to a set of MCL fields of a data source that is separate from the API based on the one or more conditions and a mapping scheme, where the mapping scheme includes a logic for mapping respective API fields to respective MCL fields. The display component 635 may be configured as or otherwise support a means for causing, for display at the user interface of the mapping service, an indication of a set of mapped fields based on the mapping. The generation component 640 may be configured as or otherwise support a means for generating a set of mock data for the set of API fields based on the mapping and a response to the indication. The storage component 645 may be configured as or otherwise support a means for storing the mapping scheme based on the generating.

In some examples, to support mapping the set of API fields to the set of MCL fields, the comparison component 650 may be configured as or otherwise support a means for determining a similarity score associated with a first MCL field of the set of MCL fields and a first API field of the set of API fields based on a field-level comparison of the set of MCL fields and the set of API fields. In some examples, to support mapping the set of API fields to the set of MCL fields, the mapping component 630 may be configured as or otherwise support a means for mapping the first MCL field to the first API field based on the similarity score including a highest similarity score associated with the field-level comparison of the set of MCL fields and the set of API fields.

In some examples, the rejection component 655 may be configured as or otherwise support a means for receiving, via the user interface of the mapping service, a second user input indicating a rejection of one or more mapped fields of the set of mapped fields.

In some examples, the mapping component 630 may be configured as or otherwise support a means for identifying one or more MCL fields of the set of MCL fields that are associated with a similarity score comprising a highest similarity score associated with a description-level comparison of the one or more MCL fields and the one or more API fields, the one or more MCL fields associated with the one or more rejected mapped fields. In some examples, the mapping component 630 may be configured as or otherwise support a means for remapping one or more API fields of the set of API fields associated with the one or more rejected mapped fields to the one or more MCL fields based on the identifying. In some examples, the display component 635 may be configured as or otherwise support a means for causing, for display at the user interface of the mapping service, an indication of the one or more remapped fields based on the remapping.

In some examples, the request component 670 may be configured as or otherwise support a means for transmitting a request for a set of example values corresponding to the one or more rejected mapped fields based on receiving the second user input. In some examples, the mapping component 630 may be configured as or otherwise support a means for identifying one or more MCL fields of the set of MCL fields that are associated with a similarity score comprising a highest similarity score associated with an example-level comparison of the one or more MCL fields and the one or more API fields based on the set of example values, the one or more MCL fields associated with the one or more rejected mapped fields. In some examples, the mapping component 630 may be configured as or otherwise support a means for remapping one or more API fields of the set of API fields associated with the one or more rejected mapped fields to the one or more MCL fields based on the identifying. In some examples, the display component 635 may be configured as or otherwise support a means for causing, for display at the user interface of the mapping service, an indication of the one or more remapped fields based on the remapping.

In some examples, to support generating the set of mock data, the acceptance component 660 may be configured as or otherwise support a means for receiving, via the user interface of the mapping service, a second user input indicating an acceptance of one or more mapped fields of the set of mapped fields based on the set of mapped fields satisfying the one or more conditions. In some examples, to support generating the set of mock data, the generation component 640 may be configured as or otherwise support a means for generating the set of mock data for the set of API fields based on receiving the second user input.

In some examples, the retrieval component 665 may be configured as or otherwise support a means for generating the set of mock data on the fly based on receiving an API request, where the set of mock data includes a set of generated mock responses to the API request.

In some examples, to support mapping the set of API fields to the set of MCL fields, the mapping component 630 may be configured as or otherwise support a means for identifying, based on a word embeddings model, meanings of a set of labels corresponding to the set of API fields.

In some examples, to support mapping the set of API fields to the set of MCL fields, the mapping component 630 may be configured as or otherwise support a means for mapping the set of API fields to the set of MCL fields based on a regular expression indicated in the first user input. In some examples, the first user input indicates a latency associated with generating the values of the mock data.

FIG. 7 shows a diagram of a system 700 including a device 705 that supports automatic field mapping for a mocking service in accordance with aspects of the present disclosure. The device 705 may be an example of or include the components of a device 505 as described herein. The device 705 may include components for bi-directional data communications including components for transmitting and receiving communications, such as a mapping service 720, an I/O controller 710, a database controller 715, a memory 725, a processor 730, and a database 735. These components may be in electronic communication or otherwise coupled (e.g., operatively, communicatively, functionally, electronically, electrically) via one or more buses (e.g., a bus 740).

The I/O controller 710 may manage input signals 745 and output signals 750 for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. In other cases, the I/O controller 710 may represent or interact with a modem, a keyboard, a mouse, a touchscreen, or a similar device. In some cases, the I/O controller 710 may be implemented as part of a processor 730. In some examples, a user may interact with the device 705 via the I/O controller 710 or via hardware components controlled by the I/O controller 710.

The database controller 715 may manage data storage and processing in a database 735. In some cases, a user may interact with the database controller 715. In other cases, the database controller 715 may operate automatically without user interaction. The database 735 may be an example of a single database, a distributed database, multiple distributed databases, a data store, a data lake, or an emergency backup database.

Memory 725 may include random-access memory (RAM) and ROM. The memory 725 may store computer-readable, computer-executable software including instructions that, when executed, cause the processor 730 to perform various functions described herein. In some cases, the memory 725 may contain, among other things, a BIOS which may control basic hardware or software operation such as the interaction with peripheral components or devices.

The processor 730 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 730 may be configured to operate a memory array using a memory controller. In other cases, a memory controller may be integrated into the processor 730. The processor 730 may be configured to execute computer-readable instructions stored in a memory 725 to perform various functions (e.g., functions or tasks supporting automatic field mapping for a mocking service).

The mapping service 720 may support data processing in accordance with examples as disclosed herein. For example, the mapping service 720 may be configured as or otherwise support a means for receiving, via a user interface of a mapping service, a first user input indicating one or more conditions for generating values of mock data into a set of API fields of an API. The mapping service 720 may be configured as or otherwise support a means for mapping the set of API fields of the API to a set of MCL fields of a data source that is separate from the API based on the one or more conditions and a mapping scheme, where the mapping scheme includes a logic for mapping respective API fields to respective MCL fields. The mapping service 720 may be configured as or otherwise support a means for causing, for display at the user interface of the mapping service, an indication of a set of mapped fields based on the mapping. The mapping service 720 may be configured as or otherwise support a means for generating a set of mock data for the set of API fields based on the mapping and a response to the indication. The mapping service 720 may be configured as or otherwise support a means for storing the mapping scheme based on the generating.

By including or configuring the mapping service 720 in accordance with examples as described herein, the device 705 may support techniques for automatic field mapping for a mocking service, which may result in improved mock implementations (e.g., for API integration and testing), reduce latencies, and improve workflow efficiencies.

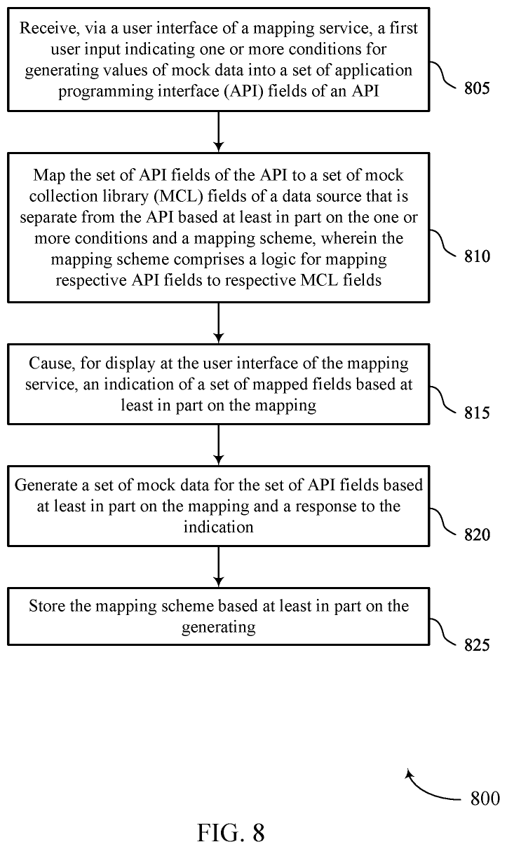

FIG. 8 shows a flowchart illustrating a method 800 that supports automatic field mapping for a mocking service in accordance with aspects of the present disclosure. The operations of the method 800 may be implemented by a mapping service or its components as described herein. For example, the operations of the method 800 may be performed by a mapping service as described with reference to FIGS. 1 through 7. In some examples, a mapping service may execute a set of instructions to control the functional elements of the mapping service to perform the described functions. Additionally, or alternatively, the mapping service may perform aspects of the described functions using special-purpose hardware.

At 805, the method may include receiving, via a user interface of a mapping service, a first user input indicating one or more conditions for generating values of mock data into a set of API fields of an API. The operations of 805 may be performed in accordance with examples as disclosed herein. In some examples, aspects of the operations of 805 may be performed by a conditions component 625 as described with reference to FIG. 6.

At 810, the method may include mapping the set of API fields of the API to a set of MCL fields of a data source that is separate from the API based on the one or more conditions and a mapping scheme, where the mapping scheme includes a logic for mapping respective API fields to respective MCL fields. The operations of 810 may be performed in accordance with examples as disclosed herein. In some examples, aspects of the operations of 810 may be performed by a mapping component 630 as described with reference to FIG. 6.

At 815, the method may include causing, for display at the user interface of the mapping service, an indication of a set of mapped fields based on the mapping. The operations of 815 may be performed in accordance with examples as disclosed herein. In some examples, aspects of the operations of 815 may be performed by a display component 635 as described with reference to FIG. 6.

At 820, the method may include generating a set of mock data for the set of API fields based on the mapping and a response to the indication. The operations of 820 may be performed in accordance with examples as disclosed herein. In some examples, aspects of the operations of 820 may be performed by a generation component 640 as described with reference to FIG. 6.

At 825, the method may include storing the mapping scheme based on the generating. The operations of 825 may be performed in accordance with examples as disclosed herein. In some examples, aspects of the operations of 825 may be performed by a storage component 645 as described with reference to FIG. 6.

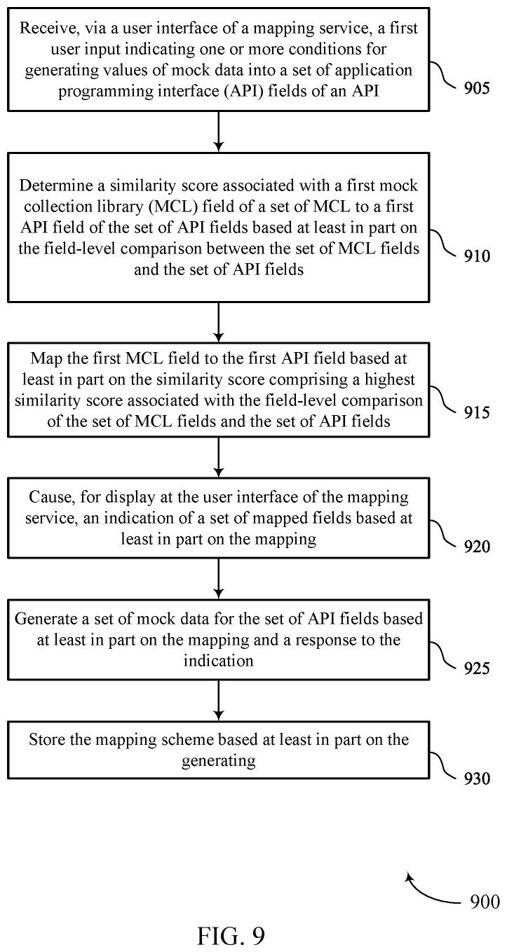

FIG. 9 shows a flowchart illustrating a method 900 that supports automatic field mapping for a mocking service in accordance with aspects of the present disclosure. The operations of the method 900 may be implemented by a mapping service or its components as described herein. For example, the operations of the method 900 may be performed by a mapping service as described with reference to FIGS. 1 through 7. In some examples, a mapping service may execute a set of instructions to control the functional elements of the mapping service to perform the described functions. Additionally, or alternatively, the mapping service may perform aspects of the described functions using special-purpose hardware.

At 905, the method may include receiving, via a user interface of a mapping service, a first user input indicating one or more conditions for generating values of mock data into a set of API fields of an API. The operations of 905 may be performed in accordance with examples as disclosed herein. In some examples, aspects of the operations of 905 may be performed by a conditions component 625 as described with reference to FIG. 6.

At 910, the method may include determining a similarity score associated with a first MCL field of a set of MCL fields and a first API field of the set of API fields based on a field-level comparison of the set of MCL fields and the set of API fields. The operations of 910 may be performed in accordance with examples as disclosed herein. In some examples, aspects of the operations of 910 may be performed by a comparison component 650 as described with reference to FIG. 6.

At 915, the method may include mapping the first MCL field to the first API field based on the similarity score including a highest similarity score associated with the field-level comparison of the set of MCL fields and the set of API fields. The operations of 915 may be performed in accordance with examples as disclosed herein. In some examples, aspects of the operations of 915 may be performed by a mapping component 630 as described with reference to FIG. 6.

At 920, the method may include causing, for display at the user interface of the mapping service, an indication of a set of mapped fields based on the mapping. The operations of 920 may be performed in accordance with examples as disclosed herein. In some examples, aspects of the operations of 920 may be performed by a display component 635 as described with reference to FIG. 6.

At 925, the method may include generating a set of mock data for the set of API fields based on the mapping and a response to the indication. The operations of 925 may be performed in accordance with examples as disclosed herein. In some examples, aspects of the operations of 925 may be performed by a generation component 640 as described with reference to FIG. 6.

At 930, the method may include storing the mapping scheme based on the generating. The operations of 930 may be performed in accordance with examples as disclosed herein. In some examples, aspects of the operations of 930 may be performed by a storage component 645 as described with reference to FIG. 6.

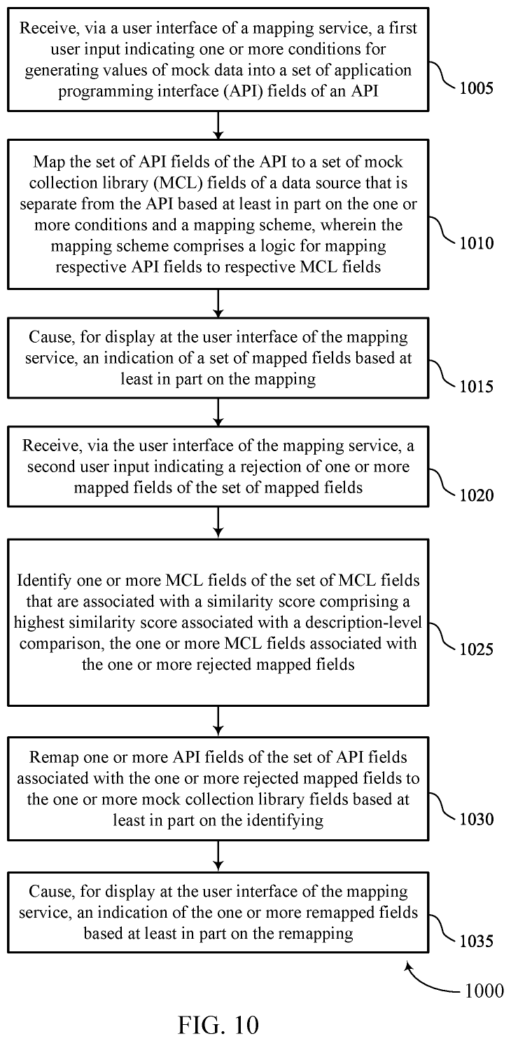

FIG. 10 shows a flowchart illustrating a method 1000 that supports automatic field mapping for a mocking service in accordance with aspects of the present disclosure. The operations of the method 1000 may be implemented by a mapping service or its components as described herein. For example, the operations of the method 1000 may be performed by a mapping service as described with reference to FIGS. 1 through 7. In some examples, a mapping service may execute a set of instructions to control the functional elements of the mapping service to perform the described functions. Additionally, or alternatively, the mapping service may perform aspects of the described functions using special-purpose hardware.

At 1005, the method may include receiving, via a user interface of a mapping service, a first user input indicating one or more conditions for generating values of mock data into a set of API fields of an API. The operations of 1005 may be performed in accordance with examples as disclosed herein. In some examples, aspects of the operations of 1005 may be performed by a conditions component 625 as described with reference to FIG. 6.

At 1010, the method may include mapping the set of API fields of the API to a set of MCL fields of a data source that is separate from the API based on the one or more conditions and a mapping scheme, where the mapping scheme includes a logic for mapping respective API fields to respective MCL fields. The operations of 1010 may be performed in accordance with examples as disclosed herein. In some examples, aspects of the operations of 1010 may be performed by a mapping component 630 as described with reference to FIG. 6.

At 1015, the method may include causing, for display at the user interface of the mapping service, an indication of a set of mapped fields based on the mapping. The operations of 1015 may be performed in accordance with examples as disclosed herein. In some examples, aspects of the operations of 1015 may be performed by a display component 635 as described with reference to FIG. 6.

At 1020, the method may include receiving, via the user interface of the mapping service, a second user input indicating a rejection of one or more mapped fields of the set of mapped fields. The operations of 1020 may be performed in accordance with examples as disclosed herein. In some examples, aspects of the operations of 1020 may be performed by a rejection component 655 as described with reference to FIG. 6.

At 1025, the method may include identifying one or more MCL fields of the set of MCL fields that are associated with a similarity score comprising a highest similarity score associated with a description-level comparison of the one or more MCL fields and the one or more API fields, the one or more MCL fields associated with the one or more rejected mapped fields. The operations of 1025 may be performed in accordance with examples as disclosed herein. In some examples, aspects of the operations of 1025 may be performed by a mapping component 630 as described with reference to FIG. 6.

At 1030, the method may include remapping one or more API fields of the set of API fields associated with the one or more rejected mapped fields to the one or more MCL fields based on the identifying. The operations of 1030 may be performed in accordance with examples as disclosed herein. In some examples, aspects of the operations of 1030 may be performed by a mapping component 630 as described with reference to FIG. 6.

At 1035, the method may include causing, for display at the user interface of the mapping service, an indication of the one or more remapped fields based on the remapping. The operations of 1035 may be performed in accordance with examples as disclosed herein. In some examples, aspects of the operations of 1035 may be performed by a display component 635 as described with reference to FIG. 6.

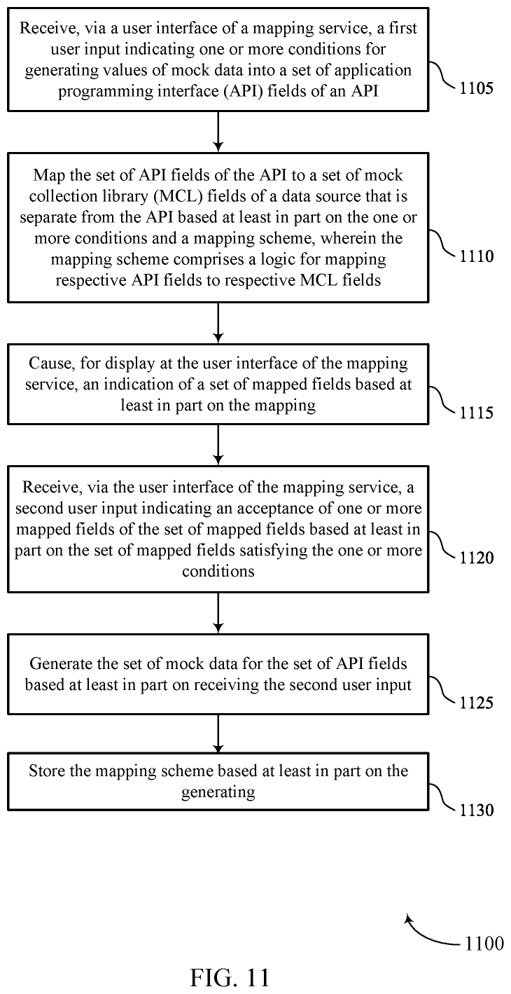

FIG. 11 shows a flowchart illustrating a method 1100 that supports automatic field mapping for a mocking service in accordance with aspects of the present disclosure. The operations of the method 1100 may be implemented by a mapping service or its components as described herein. For example, the operations of the method 1100 may be performed by a mapping service as described with reference to FIGS. 1 through 7. In some examples, a mapping service may execute a set of instructions to control the functional elements of the mapping service to perform the described functions. Additionally, or alternatively, the mapping service may perform aspects of the described functions using special-purpose hardware.

At 1105, the method may include receiving, via a user interface of a mapping service, a first user input indicating one or more conditions for generating values of mock data into a set of API fields of an API. The operations of 1105 may be performed in accordance with examples as disclosed herein. In some examples, aspects of the operations of 1105 may be performed by a conditions component 625 as described with reference to FIG. 6.

At 1110, the method may include mapping the set of API fields of the API to a set of MCL fields of a data source that is separate from the API based on the one or more conditions and a mapping scheme, where the mapping scheme includes a logic for mapping respective API fields to respective MCL fields. The operations of 1110 may be performed in accordance with examples as disclosed herein. In some examples, aspects of the operations of 1110 may be performed by a mapping component 630 as described with reference to FIG. 6.

At 1115, the method may include causing, for display at the user interface of the mapping service, an indication of a set of mapped fields based on the mapping. The operations of 1115 may be performed in accordance with examples as disclosed herein. In some examples, aspects of the operations of 1115 may be performed by a display component 635 as described with reference to FIG. 6.

At 1120, the method may include receiving, via the user interface of the mapping service, a second user input indicating an acceptance of one or more mapped fields of the set of mapped fields based on the set of mapped fields satisfying the one or more conditions. The operations of 1120 may be performed in accordance with examples as disclosed herein. In some examples, aspects of the operations of 1120 may be performed by an acceptance component 660 as described with reference to FIG. 6.

At 1125, the method may include generating the set of mock data for the set of API fields based on receiving the second user input. The operations of 1125 may be performed in accordance with examples as disclosed herein. In some examples, aspects of the operations of 1125 may be performed by a generation component 640 as described with reference to FIG. 6.

At 1130, the method may include storing the mapping scheme based on the generating. The operations of 1130 may be performed in accordance with examples as disclosed herein. In some examples, aspects of the operations of 1130 may be performed by a storage component 645 as described with reference to FIG. 6.

A method for data processing is described. The method may include receiving, via a user interface of a mapping service, a first user input indicating one or more conditions for generating values of mock data into a set of API fields of an API, mapping the set of API fields of the API to a set of MCL fields of a data source that is separate from the API based on the one or more conditions and a mapping scheme, where the mapping scheme includes a logic for mapping respective API fields to respective MCL fields, causing, for display at the user interface of the mapping service, an indication of a set of mapped fields based on the mapping, generating a set of mock data for the set of API fields based on the mapping and a response to the indication, and storing the mapping scheme based on the generating.

An apparatus for data processing is described. The apparatus may include a processor, memory coupled with the processor, and instructions stored in the memory. The instructions may be executable by the processor to cause the apparatus to receive, via a user interface of a mapping service, a first user input indicating one or more conditions for generating values of mock data into a set of API fields of an API, map the set of API fields of the API to a set of MCL fields of a data source that is separate from the API based on the one or more conditions and a mapping scheme, where the mapping scheme includes a logic for mapping respective API fields to respective MCL fields, cause, for display at the user interface of the mapping service, an indication of a set of mapped fields based on the mapping, generate a set of mock data for the set of API fields based on the mapping and a response to the indication, and store the mapping scheme based on the generating.

Another apparatus for data processing is described. The apparatus may include means for receiving, via a user interface of a mapping service, a first user input indicating one or more conditions for generating values of mock data into a set of API fields of an API, means for mapping the set of API fields of the API to a set of MCL fields of a data source that is separate from the API based on the one or more conditions and a mapping scheme, where the mapping scheme includes a logic for mapping respective API fields to respective MCL fields, means for causing, for display at the user interface of the mapping service, an indication of a set of mapped fields based on the mapping, means for generating a set of mock data for the set of API fields based on the mapping and a response to the indication, and means for storing the mapping scheme based on the generating.

A non-transitory computer-readable medium storing code for data processing is described. The code may include instructions executable by a processor to receive, via a user interface of a mapping service, a first user input indicating one or more conditions for generating values of mock data into a set of API of an API, map the set of API fields of the API to a set of MCL fields of a data source that is separate from the API based on the one or more conditions and a mapping scheme, where the mapping scheme includes a logic for mapping respective API fields to respective MCL fields, cause, for display at the user interface of the mapping service, an indication of a set of mapped fields based on the mapping, generate a set of mock data for the set of API fields based on the mapping and a response to the indication, and store the mapping scheme based on the generating.

In some examples of the method, apparatuses, and non-transitory computer-readable medium described herein, mapping the set of API fields to the set of MCL fields may include operations, features, means, or instructions for determining a similarity score associated with a first MCL field of the set of MCL fields and a first API field of the set of API fields based on a field-level comparison of the set of MCL fields and the set of API fields and mapping the first MCL field to the first API field based on the similarity score including a highest similarity score associated with the field-level comparison of the set of MCL fields and the set of API fields.

Some examples of the method, apparatuses, and non-transitory computer-readable medium described herein may further include operations, features, means, or instructions for receiving, via the user interface of the mapping service, a second user input indicating a rejection of one or more mapped fields of the set of mapped fields.

Some examples of the method, apparatuses, and non-transitory computer-readable medium described herein may further include operations, features, means, or instructions for identifying one or more MCL fields of the set of MCL fields that may be associated with a similarity score comprising a highest similarity score associated with a description-level comparison of the one or more MCL fields and the one or more API fields, the one or more MCL fields associated with the one or more rejected mapped fields, remapping one or more API fields of the set of API fields associated with the one or more rejected mapped fields to the one or more MCL fields based on the identifying, and causing, for display at the user interface of the mapping service, an indication of the one or more remapped fields based on the remapping.

Some examples of the method, apparatuses, and non-transitory computer-readable medium described herein may further include operations, features, means, or instructions for transmitting a request for a set of example values corresponding to the one or more rejected mapped fields based on receiving the second user input, identifying one or more MCL fields of the set of MCL fields that may be associated with a similarity score comprising a highest similarity score associated with an example-level comparison of the one or more MCL fields and the one or more MCL fields based on the set of example values, the one or more MCL fields associated with the one or more rejected mapped fields, remapping one or more API fields of the set of API fields associated with the one or more rejected mapped fields to the one or more MCL fields based on the identifying, and causing, for display at the user interface of the mapping service, an indication of the one or more remapped fields based on the remapping.

In some examples of the method, apparatuses, and non-transitory computer-readable medium described herein, generating the set of mock data may include operations, features, means, or instructions for receiving, via the user interface of the mapping service, a second user input indicating an acceptance of one or more mapped fields of the set of mapped fields based on the set of mapped fields satisfying the one or more conditions and generating the set of mock data for the set of API fields based on receiving the second user input.

Some examples of the method, apparatuses, and non-transitory computer-readable medium described herein may further include operations, features, means, or instructions for generating the set of mock data on the fly based on receiving an API request, where the set of generated mock data includes a set of mock responses to the API request.

In some examples of the method, apparatuses, and non-transitory computer-readable medium described herein, mapping the set of API fields to the set of MCL fields may include operations, features, means, or instructions for identifying, based on a word embeddings model, meanings of a set of labels corresponding to the set of API fields.

In some examples of the method, apparatuses, and non-transitory computer-readable medium described herein, mapping the set of API fields to the set of MCL fields may include operations, features, means, or instructions for mapping the set of API fields to the set of MCL fields based on a regular expression indicated in the first user input.

In some examples of the method, apparatuses, and non-transitory computer-readable medium described herein, the first user input indicates a latency associated with generating the values of the mock data.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for data processing, comprising:
receiving, via a user interface of a mapping service, a first user input indicating one or more conditions for generating values of mock data into a set of application programming interface (API) fields of an API;
mapping the set of API fields of the API to a set of mock collection library (MCL) fields of a data source that is separate from the API based at least in part on the one or more conditions and a mapping scheme, wherein the mapping scheme comprises a logic for mapping respective API fields to respective MCL fields;
causing, for display at the user interface of the mapping service, an indication of a set of mapped fields based at least in part on the mapping;
generating a set of mock data for the set of API fields based at least in part on the mapping and a response to the indication; and
storing the mapping scheme based at least in part on the generating.

2. The method of claim 1, wherein mapping the set of API fields to the set of MCL fields comprises:
determining a similarity score associated with a first MCL field of the set of MCL fields and a first API field of the set of API fields based at least in part on a field-level comparison of the set of MCL fields and the set of API fields; and
mapping the first MCL field to the first API field based at least in part on the similarity score comprising a highest similarity score associated with the field-level comparison of the set of MCL fields and the set of API fields.

3. The method of claim 1, further comprising:
receiving, via the user interface of the mapping service, a second user input indicating a rejection of one or more mapped fields of the set of mapped fields.

4. The method of claim 3, further comprising:
identifying one or more MCL fields of the set of MCL fields that are associated with a similarity score comprising a highest similarity score associated with a description-level comparison of the one or more MCL fields and the one or more API fields, the one or more MCL fields associated with the one or more rejected mapped fields;
remapping one or more API fields of the set of API fields associated with the one or more rejected mapped fields to the one or more MCL fields based at least in part on the identifying; and
causing, for display at the user interface of the mapping service, an indication of the one or more remapped fields based at least in part on the remapping.

5. The method of claim 3, further comprising:
transmitting a request for a set of example values corresponding to the one or more rejected mapped fields based at least in part on receiving the second user input;
identifying one or more MCL fields of the set of MCL fields that are associated with a similarity score comprising a highest similarity score associated with an example-level comparison of the one or more MCL fields and the one or more MCL fields based at least in part on the set of example values, the one or more MCL fields associated with the one or more rejected mapped fields;
remapping one or more API fields of the set of API fields associated with the one or more rejected mapped fields to the one or more MCL fields based at least in part on the identifying; and
causing, for display at the user interface of the mapping service, an indication of the one or more remapped fields based at least in part on the remapping.

6. The method of claim 1, wherein generating the set of mock data comprises:
receiving, via the user interface of the mapping service, a second user input indicating an acceptance of one or more mapped fields of the set of mapped fields based at least in part on the set of mapped fields satisfying the one or more conditions; and
generating the set of mock data for the set of API fields based at least in part on receiving the second user input.

7. The method of claim 1, further comprising:
generating the set of mock data on the fly based at least in part on receiving an API request, wherein the set of mock data comprises a set of generated mock responses to the API request.

8. The method of claim 1, wherein mapping the set of API fields to the set of MCL fields comprises:
identifying, based at least in part on a word embeddings model, meanings of a set of labels corresponding to the set of API fields.

9. The method of claim 1, wherein mapping the set of API fields to the set of MCL fields comprises:
mapping the set of API fields to the set of MCL fields based at least in part on a regular expression indicated in the first user input.

10. The method of claim 1, wherein the first user input indicates a latency associated with generating the values of the mock data.

11. An apparatus for data processing, comprising:
a processor;
memory coupled with the processor; and
instructions stored in the memory and executable by the processor to cause the apparatus to:
receive, via a user interface of a mapping service, a first user input indicating one or more conditions for generating values of mock data into a set of application programming interface (API) fields of an API;
map the set of API fields of the API to a set of MCL fields of a data source that is separate from the API based at least in part on the one or more conditions and a mapping scheme, wherein the mapping scheme comprises a logic for mapping respective API fields to respective MCL fields;
cause, for display at the user interface of the mapping service, an indication of a set of mapped fields based at least in part on the mapping;
generate a set of mock data for the set of API fields based at least in part on the mapping and a response to the indication; and
store the mapping scheme based at least in part on the generating.

12. The apparatus of claim 11, wherein the instructions to mapping the set of API fields to the set of MCL fields are executable by the processor to cause the apparatus to:
determine a similarity score associated with a first MCL field of the set of MCL fields and a first API field of the set of API fields based at least in part on a field-level comparison of the set of MCL fields and the set of API fields; and
map the first MCL field to the first API field based at least in part on the similarity score comprising a highest similarity score associated with the field-level comparison of the set of MCL fields and the set of API field.

13. The apparatus of claim 11, wherein the instructions are further executable by the processor to cause the apparatus to:
receive, via the user interface of the mapping service, a second user input indicating a rejection of one or more mapped fields of the set of mapped fields.

14. The apparatus of claim 13, wherein the instructions are further executable by the processor to cause the apparatus to:
identify one or more MCL fields of the set of MCL fields that are associated with a similarity score comprising a highest similarity score associated with a description-level comparison of the one or more MCL fields and the one or more API fields, the one or more MCL fields associated with the one or more rejected mapped fields;
remap one or more API fields of the set of API fields associated with the one or more rejected mapped fields to the one or more MCL fields based at least in part on the identifying; and
cause, for display at the user interface of the mapping service, an indication of the one or more remapped fields based at least in part on the remapping.

15. The apparatus of claim 13, wherein the instructions are further executable by the processor to cause the apparatus to:
transmit a request for a set of example values corresponding to the one or more rejected mapped fields based at least in part on receiving the second user input;
identify one or more MCL fields of the set of MCL fields that are associated a similarity score comprising a highest similarity score associated with an example-level comparison of the one or more MCL fields and the one or more MCL fields based at least in part on the set of example values, the one or more MCL fields associated with the one or more rejected mapped fields;
remap one or more API fields of the set of API fields associated with the one or more rejected mapped fields to the one or more MCL fields based at least in part on the identifying; and
cause, for display at the user interface of the mapping service, an indication of the one or more remapped fields based at least in part on the remapping.

16. The apparatus of claim 11, wherein the instructions to generate the set of mock data are executable by the processor to cause the apparatus to:
receive, via the user interface of the mapping service, a second user input indicating an acceptance of one or more mapped fields of the set of mapped fields based at least in part on the set of mapped fields satisfying the one or more conditions; and
generate the set of mock data for the set of API fields based at least in part on receiving the second user input.

17. The apparatus of claim 11, wherein the instructions are further executable by the processor to cause the apparatus to:
generate the set of mock data on the fly based at least in part on receiving an API request, wherein the set of mock data comprises a set of generated mock responses to the API request.

18. The apparatus of claim 11, wherein the instructions to mapping the set of API fields to the set of MCL fields are executable by the processor to cause the apparatus to:
identify, based at least in part on a word embeddings model, meanings of a set of labels corresponding to the set of API fields.

19. The apparatus of claim 11, wherein the instructions to mapping the set of API fields to the set of MCL fields are executable by the processor to cause the apparatus to:
map the set of API fields to the set of MCL fields based at least in part on a regular expression indicated in the first user input.

20. A non-transitory computer-readable medium storing code for data processing, the code comprising instructions executable by a processor to:
receive, via a user interface of a mapping service, a first user input indicating one or more conditions for generating values of mock data into a set of application programming interface (API) fields of an API;
map the set of API fields of the API to a set of MCL fields of a data source that is separate from the API based at least in part on the one or more conditions and a mapping scheme, wherein the mapping scheme comprises a logic for mapping respective API fields to respective MCL fields;
cause, for display at the user interface of the mapping service, an indication of a set of mapped fields based at least in part on the mapping;
generate a set of mock data for the set of API fields based at least in part on the mapping and a response to the indication; and
store the mapping scheme based at least in part on the generating.
